(19) United States
(12) Patent Application Publication
(10) Pub. No.: US 2014/0144232 A1
(43) Pub. Date: May 29, 2014

(54) SPRING FOR MICROELECTROMECHANICAL SYSTEMS (MEMS) DEVICE

(71) Applicants: Yizhen Lin, Cohoes, NY (US); Jan Mehner, Neukirchen (DE); Michael Naumann, Burgstadt (DE)

(72) Inventors: Yizhen Lin, Cohoes, NY (US); Jan Mehner, Neukirchen (DE); Michael Naumann, Burgstadt (DE)

(21) Appl. No.: 13/687,424

(22) Filed: Nov. 28, 2012

(51) Int. Cl. G01C 19/56

(52) U.S. Cl. CPC G01C 19/56
USPC 73/504.12

(57) ABSTRACT

A MEMS device (20) includes a substrate (28) and a drive mass (30) configured to undergo oscillatory motion within a plane (24) substantially parallel to a surface (50) of the substrate (28). The sensor (20) further includes drive springs (56), each of which includes a principal beam (70) and a flexion beam (72) coupled an end (74) of the principal beam (70). The flexion beam (72) is anchored to the drive mass (30) or the substrate (28). The flexion beam (72) exhibits a width (90) that is less than a width (88) of the principal beam (70). In response to oscillatory drive motion, the flexion beam (72) flexes so that the principal beam (70) rotates about a pivot point (96) within the plane (24). Thus, out-of-plane movement of the drive mass (30) is reduced thereby suppressing quadrature error.

### TECHNICAL FIELD OF THE INVENTION

The present invention relates generally to microelectromechanical systems (MEMS) devices. More specifically, the present invention relates to a spring design for a MEMS device.

### BACKGROUND OF THE INVENTION

Microelectromechanical systems (MEMS) technology has achieved wide popularity in recent years, as it provides a way to make very small mechanical structures and integrate these structures with electrical devices on a single substrate using conventional batch semiconductor processing techniques. One common application of MEMS is the design and manufacture of sensor devices. MEMS sensor devices are widely used in applications such as automotive, inertial guidance systems, household appliances, game devices, protection systems for a variety of devices, and many other industrial, scientific, and engineering systems.

### BRIEF DESCRIPTION OF THE DRAWINGS

A more complete understanding of the present invention may be derived by referring to the detailed description and claims when considered in connection with the

Figures, wherein like reference numbers refer to similar items throughout the Figures, and:

FIG. 1 shows a top view of a microelectromechanical systems (MEMS) device in the form of an inertial sensor in accordance with an embodiment;

FIG. 2 shows a top view of a portion of a spring design for the inertial sensor of FIG. 1;

FIG. 3 shows a top view of a link spring configuration for the inertial sensor of FIG. 1 in accordance with an alternative embodiment; and

FIG. 4 shows a top view of an inertial sensor in accordance with another embodiment.

### DETAILED DESCRIPTION

In vibratory microelectromechanical systems (MEMS) angular rate sensors, an inherent problem is the existence of undesirable interference signals, referred to as a quadrature component or quadrature error. Quadrature error occurs in vibrating angular rate sensors due to manufacturing imperfections that permit the suspended mass to oscillate out-of-plane of its intended drive motion. This out-of-plane motion can create an oscillation about the sense axis that can be confused with Coriolis acceleration and subsequently, the rotation rate. Unfortunately, quadrature error can result in offset error, reduced dynamic range, and increased noise for the device. A large quadrature error can even cause a device to rail so that the sense mass comes into contact with conductive electrodes potentially resulting in collision-related damage, such as a short.

A major source for quadrature error is from inadequate dimensional precision during manufacturing. For example, off-vertical ion impact from deep reactive ion etch (DRIE) plasma during etching of the MEMS structural layer can produce asymmetrically tilted etch patterns in the side walls of the elements formed in the MEMS structural layer. The asymmetrical etch profile can lead to a shift of the principle axis. As such, in-plane motion couples to out-of-plane motion. This is a major contributor to quadrature error in X- and Y-axis angular rate sensors with an out-of-plane sense mode.

Embodiments disclosed herein entail microelectromechanical systems (MEMS) devices in the form of, for example, angular rate sensors, angular accelerometer sensors, magnetic sensors, gas sensors, actuators, and so forth having one or more movable elements or masses, in which out-of-plane motion is non-ideal. In particular, embodiments include a spring design that provides in-plane motion of a movable mass and largely suppresses any non-ideal out-of-plane motion. The spring design entails a wide beam supported by thin beams at each end. Due to the flexibility of the thin beams, relative to the wide beam, the thin beams serve as mechanical hinges so that the wide beam will largely rotate, or pivot, rather than bend. As such, the spring design compensates for out-of-plane motion resulting from in-plane drive motion to suppress quadrature error.

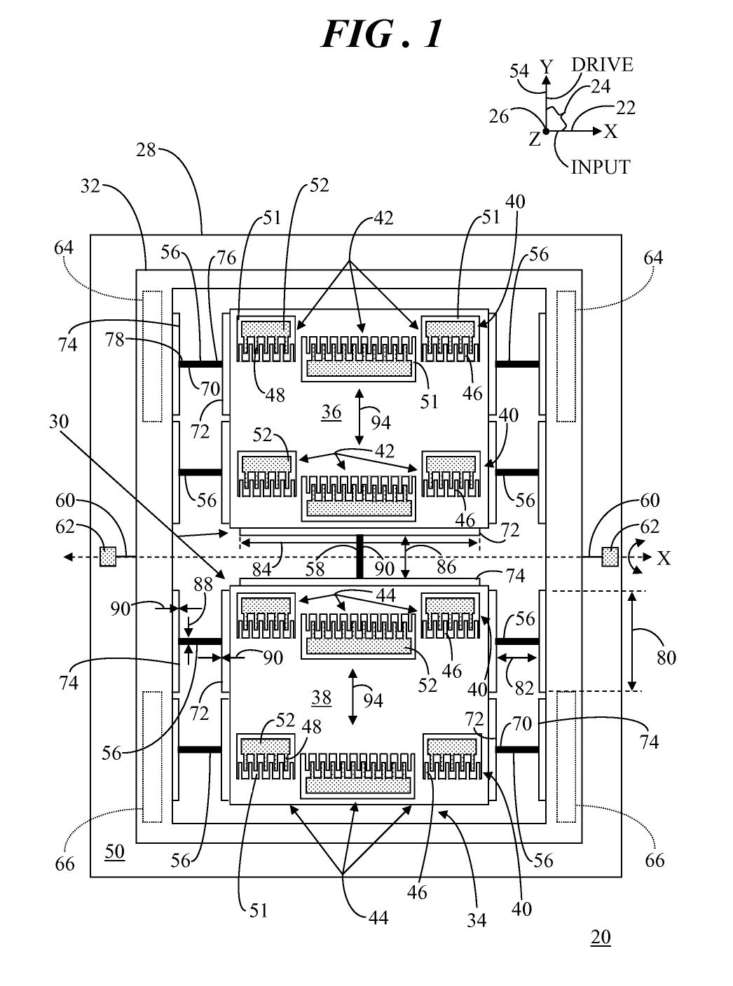

FIG. 1 shows a top view of a microelectromechanical systems (MEMS) device in the form of an inertial sensor 20 in accordance with an embodiment. Inertial sensor 20 is generally configured to sense angular rate about an axis of rotation 22, i.e., the X-axis in a three-dimensional coordinate system. Accordingly, inertial sensor 20 is referred to herein as an angular rate sensor 20. By convention, angular rate sensor 20 is illustrated as having a generally planar structure within an X-Y plane 24, wherein a Z-axis 26 extends out of the page, normal to X-Y plane 24 in FIG. 1.

Angular rate sensor 20 includes a substrate 28, a suspended mass, referred to herein as a drive mass 30, and another suspended mass, referred to herein as a sense mass 32, and various mechanical linkages which will be described in detail below. In the specific embodiment of FIG. 1, drive mass 30 resides in a central opening 34 extending through sense mass 32. Drive mass 30 includes a drive mass structure 36 and another drive mass structure 38 disposed laterally in X-Y plane 24 to drive structure 36. Drive mass structures 36 and 38 are situated symmetrically relative to one another about axis of rotation 22.

A drive system 40 resides in central opening 34 and operably communicates with each of drive mass structures 36 and 38. More specifically, drive system 40 includes sets of drive elements 42 configured to oscillate drive structure 36 and other sets of drive elements 44 configured to oscillate drive structure 38. Each set of drive elements 42 and 44 includes pairs of electrodes, referred to as movable fingers 46 and fixed fingers 48. In an embodiment, movable fingers 46 are coupled to and extend from each of drive mass structures 36 and 38. Fixed fingers 48 are fixed to a surface 50 of substrate 28 via anchors 52 and extend through cut-out regions 51 of drive mass structures 36 and 38.

Fixed fingers 48 are spaced apart from and positioned in alternating arrangement with movable fingers 46. By virtue of their attachment to drive mass structures 36 and 38, movable fingers 46 are movable together with drive mass structures 36 and 38. Conversely, due to their fixed attachment to substrate 28, fixed fingers 48 are stationary relative to movable fingers 46. Only a few movable and fixed fingers 46 and 48 are shown for clarity of illustration. Those skilled in the art should readily recognize that the quantity and structure of the movable and fixed fingers will vary in accordance with design requirements.

Fixed fingers 48 may be anchored to surface 50 of substrate 28 via anchors 52. For consistency throughout the description of the following figures, any anchoring or fixed structures, such as anchors 52 and fixed fingers 48, that are coupled or affixed to the underlying surface 50 of substrate 28 are illustrated with a stippled pattern for clarity. Conversely, any elements that are not fixed to substrate 28 do not include this stippled pattern and are therefore suspended above surface 50 of substrate 28. The various elements of angular rate sensor 20 may be produced utilizing current and upcoming surface micromachining techniques of depositing, patterning, etching, and so forth. Accordingly, although different shading and/or hatching may be utilized in the illustrations, the different elements within the structural layers are typically formed out of the same material, such as polysilicon, single crystal silicon, and the like.

The elements of MEMS angular rate sensor 20 and alternative embodiments (discussed below) are variously described as being “anchored to,” “attached to,” “attached with,” “coupled to,” “connected to,” or “interconnected with,” other elements of angular rate sensor 20. It should be understood that the terms refer to the direct or indirect physical connections of particular elements of angular rate sensor 20 that occur during their formation through patterning and etching processes of MEMS fabrication.

Drive mass structures 36 and 38 are configured to undergo oscillatory motion within X-Y plane 24. In general, an alternating current (AC) voltage may be applied to fixed fingers 48 via a drive circuit (not shown) to cause drive mass structures 36 and 38 to linearly oscillate along a Y-axis 54. In an embodiment, the AC voltage is suitably applied to fixed fingers 48 to cause movable comb fingers 46 (and thus drive mass structures 36 and 38) to move generally parallel to fixed fingers 48. Drive mass structures 36 and 38 may be suitably linked together or otherwise suitably driven to move in opposite directions, i.e., antiphase, along Y-axis 54.

Drive springs 56 couple each of drive mass structures 36 and 38, respectively, to sense mass 32. As such, drive mass structures 36 and 38 are suspended above surface 50 of substrate 28 and do not have a direct physical attachment to substrate 28. Drive springs 56 allow a large oscillatory linear motion of drive mass structures 36 and 38 in plane 24 along Y-axis 54 yet are rigid enough to transfer the Coriolis force from drive mass structures 36 and 38 to sense mass 32 along Z-axis 26. Angular rate sensor 20 further includes a link spring component 58 linking drive mass structure 36 with drive mass structure 38. Additionally, flexible support elements in the form of torsion springs 60 are coupled to sense mass 32. Torsion springs 60 connect sense mass 32 to surface 50 of substrate 28 via anchors 62.

A variety of conductive plates, or electrodes, are formed on surface 50 of substrate 28 in conjunction with the other fixed components of angular rate sensor 20. In this simplified illustration, the electrodes include sense electrodes 64 and 66, used to sense the rotation of angular rate sensor 20 about X-axis 22. Conductors (not shown) can be formed on substrate 28 to provide separate electrical connections to electrodes 64 and 66 and to sense mass 32. Electrodes 64 and 66 are formed from a conductive material such as polysilicon, and can be formed at the same time as the respective conductors if the same materials are chosen for such components. Electrodes 64 and 66 are obscured in FIG. 1 by the overlying sense mass 32. Accordingly, in FIG. 1, electrodes 64 and 66 are represented in dashed line form to illustrate their physical placement relative to sense mass 32.

Each of drive springs 56 and link spring component 58 includes a first beam, referred to herein as a principal beam 70. Additionally, each of drive springs 56 and link spring component 58 includes second and third beams, referred to herein as flexion beams 72 and 74. In accordance with a particular configuration, flexion beam 72 is coupled to an end 76 of principal beam 70 and flexion beam 74 is coupled to the opposing end 78 of principal beam 70. Flexion beam 72 for each of drive springs 56 is thus anchored to drive mass 30 (i.e., one of drive mass structures 36 and 38) and flexion beam 74 for each of drive springs 56 is thus anchored to sense mass 32. Flexion beam 72 for link spring component 58 is anchored to drive mass structure 36 and flexion beam 74 is anchored to drive mass structure 38.

For each of drive springs 56, a lengthwise dimension 80 of each of flexion beams 72 and 74 is oriented approximately parallel to one another, and a lengthwise dimension 82 of principal beam 70 is oriented approximately perpendicular to lengthwise dimension 80 of flexion beams 72 and 74. In an embodiment, lengthwise dimension 80 of flexion beam 72 may be generally equal to lengthwise dimension 80 of flexion beam 74. However, lengthwise dimension 82 of principal beam 70 need not be the same as lengthwise dimension 80, but may instead be greater than or less than lengthwise dimension 80. Likewise, for link spring component 58, a lengthwise dimension 84 of each of flexion beams 72 and 74 is oriented approximately parallel to one another, and a lengthwise dimension 86 of principal beam 70 is oriented approximately perpendicular to flexion beams 72 and 74. Like drive springs 56, lengthwise dimension 84 of flexion beam 72 for link spring component 58 is generally equal to lengthwise dimension 84 of flexion beam 74 for link spring component 58. Again, lengthwise dimension 86 of principal beam 70 for link spring component 58 may be greater than or less than lengthwise dimension 84.

Drive springs 56 and link spring component 58 are generally arranged in a plane that is substantially parallel to surface 50 of substrate 28, i.e., X-Y plane 24. As such, principal beam 70 further exhibits a first width 88 substantially parallel to X-Y plane 24. Of course, first width 88 is significantly less than lengthwise dimension 82 of principal beam 70. Additionally, each of flexion beams 72 and 74 exhibits generally the same width, referred to herein as a second width 90, substantially parallel to X-Y plane 24. Of course, second width 90 is significantly less than lengthwise dimension 80 of flexion beams 72 and 74. Additionally, second width 90 of each of flexion beams 72 and 74 is less than first width 88 of principal beam 70.

In accordance with an embodiment, principal beam 70 is not intended to bend in response to oscillatory drive motion imparted on drive mass 30 via drive system 40 so that principal beam 70 and, commensurately, drive mass 30 undergo motion out of X-Y plane 24. Instead, this bending occurs in flexion beams 72 and 74. That is, second width 90 of each of flexion beams 72 and 74 is significantly less than first width 88 so that flexion beams 72 and 74 will bend in lieu of the thicker, and therefore stiffer, principal beam 70. Consequently, any possible out-of-plane bending of principal beam 70, which might otherwise result in quadrature error at sense mass 32, is negligible as compared to the bending of flexion beams 72 and 74.

For each of drive springs 56, lengthwise dimension 82 of principal beam 70 is oriented approximately perpendicular to the drive axis, i.e., Y-axis 54, for drive mass 30. Due to their perpendicular orientation relative to principal beam 70, lengthwise dimension 80 of flexion beams 72 and 74 for each of drive springs 56 is parallel to Y-drive axis 54. For link spring component 58 coupling drive mass structure 36 to drive mass structure 38, lengthwise dimension 86 of principal beam 70 is oriented approximately parallel to drive axis 54, and lengthwise dimension 84 of flexion beams 72 and 74 is oriented approximately perpendicular to drive axis 54.

In operation, drive mass structures 36 and 38 of drive mass 30 undergo oscillatory motion within X-Y plane 24 in antiphase in a linear drive direction 94 substantially parallel to the drive axis, i.e., Y-axis 54. In the illustrated embodiment, wherein the axis of rotation is designated as X-axis 22, drive mass structures 36 and 38 linearly oscillate in opposite directions. The design of drive springs 56 and link spring component 58 effectively suppresses out-of-plane movement of drive mass structures 36 and 38 along sense axis 26 so that drive mass structures 36 and 38 linearly oscillate in X-Y plane 24 substantially parallel to Y-axis 54 (i.e., up and down in FIG. 1) with negligible phase error.

Once drive mass 30 is put into linear oscillatory motion along Y-axis 54, sense mass 32 is capable of detecting angular rate, i.e., angular velocity, induced by angular rate sensor 20 being rotated about X-axis 22. In particular, as a result of a Coriolis acceleration component, torsion springs 60 enable sense mass 32 to oscillate out of X-Y plane 24 as a function of angular rate, i.e., the angular velocity, of angular rate sensor 20 about X-axis of rotation 22. This movement has an amplitude that is proportional to the angular rotation rate of angular rate sensor 20 about the input axis, i.e., X-axis 22.

Drive springs 56 couple sense mass 32 to drive mass 30 such that sense mass 32 is substantially decoupled from drive mass 30 with respect to the linear oscillatory motion of drive mass 30 in linear drive direction 94. However, sense mass 32 is coupled to drive mass 30 with respect to the oscillatory motion out of X-Y plane 24 of sense mass 32. Thus, sense mass 32 is linked to drive mass 30 so that both sense mass 32 and drive mass 30 jointly undergo out-of-plane motion due to the Coriolis forces during rotation of angular rate sensor 20 about X-axis of rotation 22. As sense mass 32 undergoes the oscillatory out-of-plane motion, the position change is sensed as changes in capacitance by electrodes 64 and 66. This change in capacitance, sensed at electrodes 64 and 66, is processed electronically in the conventional manner to obtain the angular rate of angular rate sensor 20 about X-axis of rotation 22.

It is the coupling between the drive motion of drive mass 30 along Y-axis 54 and the angular rate of angular rate sensor 20 about X-axis of rotation 22 that produces the Coriolis force which, in turn, displaces sense mass 32 out of X-Y plane 24. The Coriolis force is very small in magnitude. In some prior art inertial sensors, the asymmetrically tilted etch patterns in the side walls of the elements formed in the MEMS structural layer, such as prior art drive springs, can result in out-of-plane motion of drive mass 30 and commensurately, sense mass 32, in response to the linear oscillatory drive motion of drive mass 30 in linear drive direction 94. In prior art drive spring designs, this out-of-plane motion of drive mass 30 is caused by the bending, or twisting, of the drive springs out of the desired X-Y plane 24 when the linear oscillatory drive motion is imparted on drive mass 30 via drive system 40. When Z-axis 26 is the sense axis, this out-of-plane drive motion couples mechanically to the sense motion, i.e. the displacement of sense mass 32, resulting in a quadrature error, i.e., a quadrature signal.

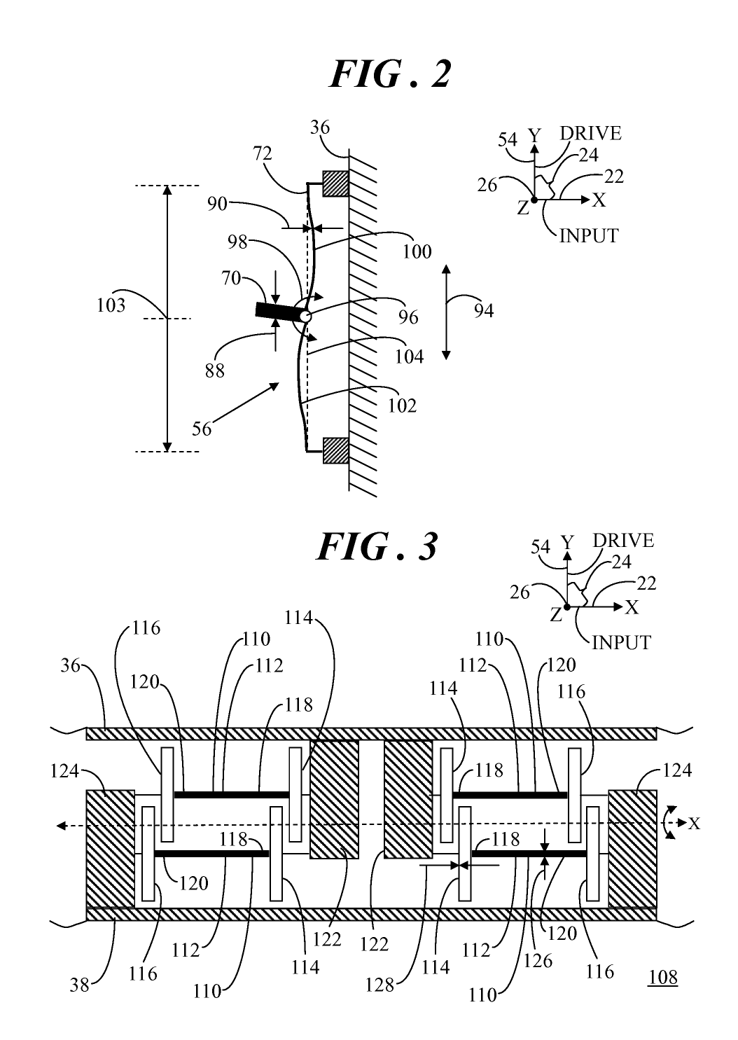

FIG. 2 shows a top view of a portion of a spring design for angular rate sensor 20 (FIG. 1). In particular, FIG. 2 shows a portion of one of drive springs 56. Although only a portion of one drive spring 56 is shown anchored to drive mass structure 36 of drive mass 30 (FIG. 1), it should be understood that the following discussion applies equivalently to each of drive springs 56 and link spring component 58, as well as their anchored connection to drive mass structure 38 and/or their anchored connection to sense mass 32.

The intersection of flexion beam 72 with principal beam 70 forms a pivot point 96 having a pivot axis that is substantially perpendicular to surface 50 (FIG. 1) of substrate 28 (FIG. 1). As demonstrated in FIG. 2, when oscillatory motion is imparted on drive mass structure 36 in linear drive direction 94, flexion beam 72 flexes to enable pivotal motion 98 of principal beam 70 about pivot point 96.

More particularly, flexion beam 72 can be subdivided into a first flex element 100 and a second flex element 102 with principal beam 70 interposed between first and second flex elements 100 and 102. First and second flex elements 100 and 102 are substantially the same length so that the intersection of principal beam 70 with flexion beam 72 occurs at an approximate midpoint 103 of lengthwise dimension 80 of flexion beam 72. Oscillatory motion imparted on drive mass structure 36 causes principal beam 70 to rotate, or pivot, about pivot point 96. During this oscillatory motion, first and second flex elements 100 and 102 exhibiting width 90 that is significantly thinner than width 88 of principal beam 70 are deformed but with an opposite bending direction, as compared to their unbent position, where the unbent position is represented by a dashed line 104. The opposite direction of bending of first and second flex elements 100 and 102 compensates for any out-of-plane motion caused by an asymmetric etch profile so that the wider principal beam 70 rotates about pivot point 96 instead of bends. Consequently, out-of-plane motion of drive mass 30 is reduced. Because sense mass 32 is coupled to drive mass 30, the corresponding out-of-plane motion of sense mass 32 is also reduced so that quadrature error is largely suppressed.

The spring design of drive springs 56 and link spring component 58 having principal beam 70 and flexion beams 72 and 74 coupled to opposing ends of principal beam 70 can be readily adapted in a wide variety of angular rate sensor configurations in order to reduce out-of-plane motion of a suspended mass, thereby suppressing quadrature error. In addition, although an angular rate sensor and the suppression of quadrature error is described in detail herein, the spring design of drive springs 56 can be readily adapted to a variety of MEMS devices in which in-plane motion is desired, and non-ideal out-of-plane motion is to be suppressed.

FIG. 3 shows a top view of a link spring configuration 108 for angular rate sensor 20 (FIG. 1) in accordance with an alternative embodiment. Link spring configuration 108 is implemented in lieu of link spring component 58 (FIG. 1) in angular rate sensor 20. Link spring configuration 108 includes a number of link springs 110, each of which includes a principal beam 112 and flexion beams 114 and 116 coupled to opposing ends 118 and 120 of principal beam. In the illustrated embodiment, flexion beams 114 are anchored to a suspended mass, e.g., drive mass structure 36, via an intermediate suspended structure 122. In addition, flexion beams 116 are anchored to another suspended mass, e.g., drive mass structure 38, via another intermediate suspended structure 124.

As discussed above, a first width 126 of each of principal beams 112 is wider than a second width 128 of each of flexion beams 114 and 116. Like link spring component 58, the mechanical coupling of drive mass structures 36 and 38 via link spring 110 effectively suppresses out-of-plane movement of drive mass structures 36 and 38 along sense axis 26 (FIG. 1) so that drive mass structures 36 and 38 linearly oscillate in antiphase in a plane that is substantially parallel to Y-axis 54 with negligible phase error.

The spring design discussed above was implemented in a MEMS tuning fork angular rate sensor 20 where drive mass structures 36 and 38 are linearly oscillated in X-Y plane 24 parallel to Y-axis 54, the input axis is X-axis 22, and rotation about X-axis 22 is sensed along Z-axis 26. In another alternative embodiment, the spring design may be implemented in a rotary disk angular rate sensor.

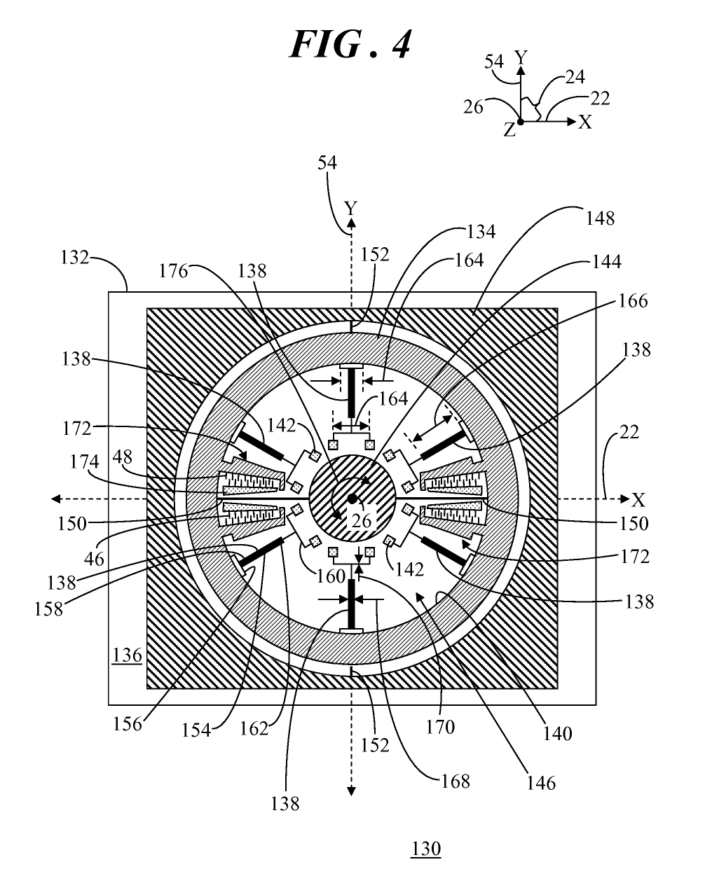

FIG. 4 shows a top view of an inertial sensor, in the form of an angular rate sensor 130, in accordance with another embodiment. Angular rate sensor 130 is a MEMS rotary disk gyroscope. Accordingly, angular rate sensor 130 is referred to herein as rotary disk gyroscope 130. Rotary disk gyroscope 130 includes a substrate 132 and a drive mass 134 suspended above and flexibly coupled to a surface 136 of substrate 132 by multiple drive springs 138. More particularly, each of drive springs 138 extends between an inner perimeter 140 of drive mass 134 and is fastened to an anchor 142 formed on substrate 132.

Angular rate sensor 130 further includes a sense mass 144 residing in a central opening 146 extending through drive mass 134 and another sense mass 148 surrounding drive mass 134. Sense mass 144 is connected to drive mass 134 with flexible support elements, i.e., torsion springs 150, that enable sense mass 144 to oscillate or pivot about an axis of rotation, i.e., X-axis 22. Accordingly, the axis of rotation is referred to herein as X-axis of rotation 22. Sense mass 148 is also attached to drive mass 134 with flexible support elements, i.e., torsion springs 152 that enable sense mass 148 to oscillate or pivot about another axis of rotation, i.e., Y-axis 54. Hence, this axis of rotation is referred to herein as Y-axis of rotation 54.

Drive mass 134 is illustrated with upwardly and rightwardly directed narrow hatching, sense mass 144 is illustrated with upwardly and rightwardly directed wide hatching, sense mass 148 is illustrated with downwardly and rightwardly directed wide hatching, and anchors 142 are illustrated with a stippled pattern to distinguish the different elements produced within the structural layers of MEMS rotary disk gyroscope 130. These different elements within the structural layers may be produced utilizing current and upcoming surface micromachining techniques of depositing, patterning, etching, and so forth. Accordingly, although different shading and/or hatching is utilized in the illustrations, the different elements within the structural layers are typically formed out of the same material, such as polysilicon, single crystal silicon, and the like.

Each of drive springs 138 includes a principal beam 154, a flexion beam 156 coupled to an end 158 of principal beam 154, and another flexion beam 160 coupled to the opposing end 162 of principal beam 154. In this embodiment, flexion beam 156 is anchored to the suspended mass, i.e., drive mass 134, and flexion beam 160 is anchored to substrate 132 via anchors 142.

Drive springs 138 share many of the same design features as drive springs 56 (FIG. 1). In particular, for each of drive springs 138, a lengthwise dimension 164 of each of flexion beams 156 and 160 is oriented approximately parallel to one another, and a lengthwise dimension 166 of principal beam 154 is oriented approximately perpendicular to lengthwise dimension 164 of each of flexion beams 156 and 160. Again, lengthwise dimension 166 of principal beam 154 need not be the same as lengthwise dimension 164, but may instead be greater than or less than lengthwise dimension 164 of flexion beams 156 and 160.

Drive springs 138 are generally arranged in a plane that is substantially parallel to surface 136 of substrate 132, i.e., X-Y plane 24. As such, principal beam 154 further exhibits a first width 168 in X-Y plane 24. Additionally, each of flexion beams 156 and 160 exhibits generally the same width, referred to herein as a second width 170, in X-Y plane 24. Second width 170 of each of flexion beams 156 and 160 is less than first width 168 of principal beam 154.

Rotary disk gyroscope 130 further includes a drive system 172 that includes movable fingers 48 extending from drive mass 134 and fixed fingers 46 coupled to substrate 132 via anchors 174. Drive mass 134 is configured to undergo oscillatory motion about a drive axis that is perpendicular to surface 136 of substrate 132, as represented by a bi-directional arrow 176. That is, the multiple drive springs 138 are configured to enable drive mass 134 to oscillate about the drive axis. In this example, the drive axis is a Z-axis 26. Accordingly, Z-axis 26 is referred to herein as drive axis 26.

As shown in FIG. 4, lengthwise dimension 166 of principal beam 154 of each of drive springs 138 is radially oriented relative to drive axis 26. Accordingly, principal beams 154 are arranged about drive axis 26 like spokes in a wheel. In addition, lengthwise dimension 164 of each of flexion beams 156 and 160 is approximately tangentially oriented relative to drive axis 26, That is, lengthwise dimension 164 of each of flexion beams 156 and 160 is approximately orthogonal to lengthwise dimension 166 of principal beam 154.

To operate rotary disk gyroscope 130, drive mass 134, sense mass 144, and sense mass 148 are mechanically oscillated together in X-Y plane 24 generally parallel to surface 136 of substrate 132. That is, drive mass 134 is actuated by drive system 172 to oscillate about drive axis 26. Each of sense masses 144 and 148 oscillate together with drive mass 134 when drive mass 134 is driven by drive system 172. Once put into oscillatory motion 176, sense mass 144 is capable of detecting angular velocity, i.e., the angular rotation rate, of gyroscope 130 about Y-axis of rotation 54, where the angular velocity about Y-axis of rotation 54 produces a Coriolis acceleration that causes sense mass 144 to oscillate about X-axis of rotation 22 at an amplitude that is proportional to the angular velocity of rotary disk gyroscope 130 about Y-axis of rotation 54. By a similar principle, sense mass 148 is capable of detecting angular velocity of rotary disk gyroscope 130 about X-axis of rotation 22. That is, as rotary disk gyroscope 130 experiences an angular velocity about X-axis of rotation 22, a Coriolis acceleration is produced that causes sense mass 148 to oscillate about Y-axis of rotation 54 at an amplitude that is proportional to the angular velocity of rotary disk gyroscope 130 about X-axis of rotation 22. Thus, rotary disk gyroscope 130 provides dual axis sensing. Electrodes (not visible) underlying sense mass 144 and sense mass 148 are configured to detect their respective output signals.

Like drive springs 56, principal beam 154 of each of drive springs 138 is not intended to bend in response to oscillatory drive motion imparted on drive mass 134 via the fixed and movable fingers 46 and 48, respectively, of drive system 172. Instead, this bending occurs in flexion beams 156 and 160 in a similar manner as that described in connection with FIG. 2. That is, second width 170 of each of flexion beams 156 and 160 is significantly less than first width 168 of principal beam 154 so that flexion beams 156 and 160 will bend in lieu of the thicker, and therefore stiffer, principal beam 154. Consequently, any possible out-of-plane bending of principal beam 154, which might otherwise result in quadrature error at sense masses 144 and 148, is negligible as compared to the bending of flexion beams 156 and 160.

One example provided above is a single-axis “tuning fork” angular rate sensor for detecting angular velocity about an X-axis that is parallel to the plane of the substrate. Another example provided above is a dual-axis sensing rotary disk gyroscope. Those skilled in the art will readily appreciate that in alternative embodiments, a single axis angular rate sensor configuration may be provided that does not include a sense mass but instead excites a secondary oscillation in the drive mass due to the Coriolis acceleration component. Still other angular rate sensor configurations may not include two drive masses driven in antiphase as shown above. Alternatively, various single and dual axis inertial sensor designs may be envisioned with a different arrangement and location of fixed and movable fingers. Each of these various embodiments can still achieve the benefit associated with a spring design that compensates for out-of-plane movement resulting from asymmetric tilt angles in the sidewalls of the structural elements, and therefore suppresses quadrature error.

In summary, embodiments of the invention entail microelectromechanical systems (MEMS) inertial sensor devices in the form of angular rate sensors and angular accelerometer sensors having one or more sense masses, in which quadrature error is suppressed. In particular, embodiments include a spring design that effectively suppresses quadrature error in the sense direction. The spring design entails a wide beam supported by thin beams at each end for an angular rate sensor. Due to the flexibility of the thin beams, relative to the wide beam, the thin beams serve as mechanical hinges so that the wide beam will largely rotate instead of bend in the presence of oscillatory drive motion. As such, the spring design compensates for out-of-plane motion resulting from in-plane drive motion to suppress quadrature error.

Although the preferred embodiments of the invention have been illustrated and described in detail, it will be readily apparent to those skilled in the art that various modifications may be made therein without departing from the spirit of the invention or from the scope of the appended claims. That is, it should be appreciated that the exemplary embodiments are only examples, and are not intended to limit the scope, applicability, or configuration of the invention.

What is claimed is:

1. A microelectromechanical systems (MEMS) device comprising:
a substrate having a surface;
a drive mass configured to undergo oscillatory motion within a plane substantially parallel to said surface; and
drive springs, each of said drive springs including a first beam and a second beam coupled to an end of said first beam, said second beam being anchored to one of said drive mass and said substrate, said first beam exhibiting a first width substantially parallel to said plane, and said second beam exhibiting a second width substantially parallel to said plane, said second width being less than said first width.

2. A MEMS device as claimed in claim 1 wherein a first lengthwise dimension of said first beam is oriented approximately perpendicular to a second lengthwise dimension of said second beam.

3. A MEMS device as claimed in claim 1 wherein said end of said first beam is coupled to a midpoint of said second beam relative to a lengthwise dimension of said second beam.

4. A MEMS device as claimed in claim 1 wherein an intersection of said second beam with said first beam forms a pivot point, and said second beam flexes to enable pivotal motion of said first beam within said plane about said pivot point in response to said oscillatory motion.

5. A MEMS device as claimed in claim 4 wherein said second beam includes:
a first flex element, said first flex element flexing in a first direction in response to said oscillatory motion; and
a second flex element, said end of said first beam being interposed between said first and second flex elements, said second flex element flexing in a second direction that is opposite to said first direction, said first and second flex elements flexing in response to said oscillatory motion.

6. A MEMS device as claimed in claim 1 wherein said end is a first end, and said each of said drive springs further comprises a third beam coupled to a second end of said first beam, said third beam exhibiting a third width substantially parallel to said plane that is less than said first width.

7. A MEMS device as claimed in claim 6 further comprising a suspended mass, said third beam being anchored to said suspended mass.

8. A MEMS device as claimed in claim 6 wherein said third width is approximately equivalent to said second width.

9. A MEMS device as claimed in claim 6 wherein said third beam is oriented approximately parallel said second beam.

10. A MEMS device as claimed in claim 6 wherein a second lengthwise dimension of said second beam is approximately equivalent to a third lengthwise dimension of said third beam.

11. A MEMS device as claimed in claim 1 wherein said drive mass is configured to undergo said oscillatory motion in a linear drive direction that is substantially parallel to said surface of said substrate, and a lengthwise dimension of said first beam is oriented approximately perpendicular to said drive direction.

12. A MEMS device as claimed in claim 11 wherein said lengthwise dimension is a first lengthwise dimension, and a second lengthwise dimension of said second beam is oriented approximately parallel to said linear drive direction.

13. A MEMS device as claimed in claim 1 wherein said drive mass is configured to undergo said oscillatory motion about a drive axis that is substantially perpendicular to said surface of said substrate, and a lengthwise dimension of said first beam is radially oriented relative to said drive axis.

14. A MEMS device as claimed in claim 13 wherein said lengthwise dimension is a first lengthwise dimension, and a second lengthwise dimension of said second beam is approximately tangentially oriented relative to said drive axis.

15. A microelectromechanical systems (MEMS) device comprising:
a substrate having a surface;
a drive mass configured to undergo oscillatory motion within a plane substantially parallel to said surface;
a suspended mass; and
drive springs connecting said suspended mass with said drive mass, each of said drive springs including a first beam and a second beam coupled to an end of said first beam, said second beam being anchored to one of said drive mass and said suspended mass, said first beam exhibiting a first width substantially parallel to said plane, and said second beam exhibiting a second width substantially parallel to said plane, said second width being less than said first width, wherein an intersection of said second beam with said first beam forms a pivot point, and said second beam flexes to enable pivotal motion of said first beam within said plane about said pivot point in response to said oscillatory motion.

16. A MEMS device as claimed in claim 15 wherein said end is a first end, and said each of said drive springs further comprises a third beam coupled to a second end of said first beam, said third beam being anchored to the other of said drive mass and said suspended mass, said third beam exhibiting a third width substantially parallel to said plane that is less than said first width.

17. A MEMS device as claimed in claim 15 wherein said drive mass is configured to undergo said oscillatory motion in a linear drive direction that is substantially parallel to said surface of said substrate, a first lengthwise dimension of said first beam is oriented approximately perpendicular to said drive direction, and a second lengthwise dimension of said second beam is oriented approximately parallel to said linear drive direction.

18. A MEMS device as claimed in claim 15 wherein said drive mass is configured to undergo said oscillatory motion about a drive axis that is substantially perpendicular to said surface of said substrate, a first lengthwise dimension of said first beam is radially oriented relative to said drive axis, and a second lengthwise dimension of said second beam is approximately tangentially oriented relative to said drive axis.

19. A microelectromechanical systems (MEMS) device comprising:
a substrate having a surface;
a drive mass configured to undergo oscillatory motion within a plane substantially parallel to said surface;
a suspended mass; and
drive springs connecting said suspended mass with said drive mass, each of said drive springs including:
a first beam exhibiting a first width substantially parallel to said plane;
a second beam coupled to a first end of said first beam, said second beam being anchored to said drive mass, said second beam exhibiting a second width substantially parallel to said plane, said second width being less than said first width; and
a third beam coupled to a second end of said first beam, said third beam being anchored to said suspended mass, said third beam exhibiting a third width substantially parallel to said plane, said third width being less than said first width, wherein in response to said oscillatory motion, said second width of said second beam and said third width of said third beam enable flexion of said second and third beams relative to said first beam so that motion of said first beam occurs substantially within said plane.

20. A MEMS device as claimed in claim 19 wherein:
said third beam is oriented approximately parallel said second beam; and
said first beam is oriented approximately perpendicular to said second and third beams.
